(19) United States
(12) Patent Application Publication
(10) Pub. No.: US 2010/0250826 A1
(43) Pub. Date: Sep. 30, 2010

(54) MEMORY SYSTEMS WITH A PLURALITY OF STRUCTURES AND METHODS FOR OPERATING THE SAME

(75) Inventor: Joe Jeddeloh, Shoreview, MN (US)

Correspondence Address: LEFFERT JAY & POLGLAZE, P.A., P.O. BOX 581009, MINNEAPOLIS, MN, 55458-1009, US

(73) Assignee: Micron Technology, Inc.

(21) Appl. No.: 12/410,005

(22) Filed: Mar. 24, 2009

(51) Int. Cl. G06F 12/00; G06F 12/08

(52) U.S. Cl. 711/103; 711/114; 711/102; 711/E12.001; 711/E12.017

(57) ABSTRACT

Memory systems, such as solid state drives, and methods of operating such memory systems are disclosed, such as those adapted to provide parallel processing of data using redundant array techniques. Individual flash devices or channels containing multiple flash devices are operated as individual drives in an array of redundant drives. Ranges of physical addresses corresponding to logical addresses are provided to a host for performing read and write operations on different channels, such as to improve read variability.

### FIELD

The present disclosure relates generally to memory systems, such as solid state drives (SSDs) and in particular the present disclosure relates to the user of multiple channels in such systems.

### BACKGROUND

Electronic devices commonly have some type of memory system, such as a bulk storage device, available to them. A common example is a hard disk drive (HDD). HDDs are capable of large amounts of storage at relatively low cost, with current consumer HDDs available with over one terabyte of capacity.

HDDs generally store data on rotating magnetic media or platters. Data is typically stored as a pattern of magnetic flux reversals on the platters. To write data to a typical HDD, the platter is rotated at high speed while a write head floating above the platter generates a series of magnetic pulses to align magnetic particles on the platter to represent the data. To read data from a typical HDD, resistance changes are induced in a magnetoresistive read head as it floats above the platter rotated at high speed. In practice, the resulting data signal is an analog signal whose peaks and valleys are the result of the magnetic flux reversals of the data pattern. Digital signal processing techniques called partial response maximum likelihood (PRML) are then used to sample the analog data signal to determine the likely data pattern responsible for generating the data signal.

HDDs have certain drawbacks due to their mechanical nature. HDDs are susceptible to damage or excessive read/write errors due to shock, vibration or strong magnetic fields. In addition, they are relatively large users of power in portable electronic devices.

Another example of a bulk storage device is a solid state drive (SSD). Instead of storing data on rotating media, SSDs utilize semiconductor memory devices to store their data, but often include an interface and form factor making them appear to their host system as if they are a typical HDD. The memory devices of SSDs are typically non-volatile flash memory devices.

Flash memory devices have developed into a popular source of non-volatile memory for a wide range of electronic applications. Flash memory devices typically use a one-transistor memory cell that allows for high memory densities, high reliability, and low power consumption. Changes in threshold voltage of the cells, through programming of charge storage nodes (e.g., floating gates or trapping layers) or other physical phenomena (e.g., phase change or polarization), determine the data value of each cell. Common uses for flash memory and other non-volatile memory include personal computers, personal digital assistants (PDAs), digital cameras, digital media players, digital recorders, games, appliances, vehicles, wireless devices, mobile telephones, and removable memory modules, and the uses for non-volatile memory continue to expand.

Unlike HDDs, the operation of SSDs is generally not subject to vibration, shock or magnetic field concerns due to their solid state nature. Similarly, without moving parts, SSDs have lower power requirements than HDDs. However, SSDs currently have much lower storage capacities compared to HDDs of the same form factor and a significantly higher cost for equivalent storage capacities.

One issue with managing flash devices in SSDs is the large variability in read access times. If the flash device has begun a program or erase cycle, it is unable to service a read request for a period of time. This period of time can be relatively long compared to read times, and is variable depending upon a number of factors. As the device wears, erase times increase. There is no guarantee of uniformity between devices, since wear can occur at different rates. This results in highly variable read latency. The host application is not aware of which flash devices are currently performing write or erase commands. This is because of the use of a logical block address (LBA) table which is present on the drive. A logical to physical translation occurs on the drive. The host sends logical addresses to the drive, and the drive itself creates the physical addresses using the LBA table.

For the reasons stated above, and for other reasons stated below which will become apparent to those skilled in the art upon reading and understanding the present specification, there is a need in the art for improved read variability in SSDs, for example.

### BRIEF DESCRIPTION OF DRAWINGS

FIG. 1 is a block diagram of a solid state drive according to an embodiment of the present invention;

FIG. 2 is a block diagram of a solid state drive according to another embodiment of the present invention;

FIG. 3 is a block diagram of a RAID array of solid state drives according to another embodiment of the present invention; and

FIG. 4 is a flow chart diagram of a method according to another embodiment of the present invention.

### DETAILED DESCRIPTION

In the following detailed description of the embodiments, reference is made to the accompanying drawings that form a part hereof. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

The following detailed description is, therefore, not to be taken in a limiting sense, and the scope of the present disclosure is defined only by the appended claims, along with the full scope of equivalents to which such claims are entitled.

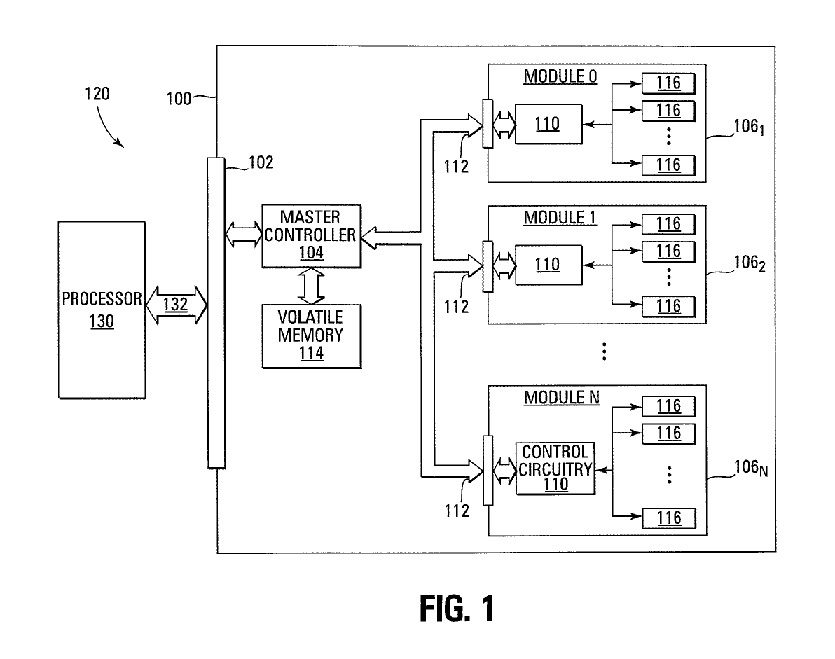

FIG. 1 is a block diagram of a memory system, such as a solid state drive (SSD) 100, in communication with (e.g., coupled to) a memory access device, such as a processor 130, as part of an electronic system 120, according to one embodiment of the disclosure. The electronic system 120 may be considered a host of the SSD 100 in that it controls the operation of the SSD 100 through, for example, its processor 130. Some examples of electronic systems include personal computers, laptop computers, personal digital assistants (PDAs), digital cameras, digital media players, digital recorders, electronic games and the like. The processor 130 may be a disk drive controller or other external processor. Typically there exists a communication bus 132 employing a standard protocol that is used to connect the processor 130 and the SSD 100. The communication bus 132 typically consists of multiple signals including address, data, power and various I/O signals. The type of communication bus 132 will depend on the type of drive interface being utilized in the system 120. Examples of some conventional disk drive interface bus protocols are Integrated Drive Electronics (IDE), Advanced Technology Attachment (ATA), Serial ATA (SATA), Parallel ATA (PATA), Fibre Channel and Small Computer System Interface (SCSI). Other drive interfaces exist and are known in the art. It should be noted that FIG. 1 has been simplified to focus on the embodiments of the disclosure. Additional or different components, connections and I/O signals could be implemented as are known in the art without departing from the scope of the disclosure. For example, the SSD 100 could include power conditioning/distribution circuitry, a dedicated controller for volatile memory 114, etc. However, such additional components are not necessary to an understanding of this disclosure.

The SSD 100 according to one embodiment of the disclosure, as illustrated in FIG. 1, includes an interface 102 to allow a processor 130, e.g., a drive controller, to interact with the SSD 100 over communication bus 132. The interface 102 may be one of many standardized connectors commonly known to those skilled in the art. Some examples of these interface 102 connectors are IDE, enhanced IDE, ATA, SATA, and Personal Computer Memory Card International Association (PCMCIA) connectors. As various embodiments of the disclosure can be configured to emulate a variety of conventional type HDDs, other disk drive connectors may also be utilized at the interface 102.

The SSD 100 of FIG. 1 also includes a master controller 104, a number of memory modules 1061-106N, and a volatile memory 114. Some of the functions performed by the master controller 104 are to manage operations within the SSD 100 and communicate with devices external to the SSD 100 such as the processor 130 over the communication bus 132. Memory modules 1061-106N act as the bulk storage media for the SSD 100. Volatile memory 114 acts as buffer storage for data transfers to and from the SSD 100.

The master controller 104 manages the various operations of the SSD 100. As discussed, an SSD may be used as a drop in replacement for a standard HDD and there exist many standardized HDDs which have standard interfaces and communication protocols. Thus, one of the many functions of the master controller 104 is to emulate the operation of one of these standardized HDD protocols. Another function of the master controller 104 can be to manage the operation of the memory modules 106 installed in the SSD 100. The master controller 104 can be configured to communicate with the memory modules 106 using a variety of standard communication protocols. For example, in one embodiment of the disclosure, the master controller 104 interacts with the memory modules 106 using a SATA protocol. Other embodiments may utilize other communication protocols to communicate with the memory modules 106. The master controller 104 may also perform additional functions relating to the memory modules such as ECC checking. Implementation of the master controller 104 may be accomplished by using hardware or a hardware/software combination. For example, the master controller 104 may be implemented in whole or in part by a state machine. The master controller 104 is further configured to perform one or more methods of the present disclosure.

Memory modules 106 are coupled to the master controller 104 using internal communication bus 112. Communication between the master controller 104 and the memory modules 106 may be implemented by utilizing a common bus 112 as shown, and/or discrete connections between the master controller 104 and each memory module 106.

A respective controller, such as control circuitry 110, manages the operation of the non-volatile memory devices 116 on each memory module 1061-106N. Memory devices 116 may be flash memory devices. The control circuitry 110 may also act to translate the communication protocol utilized by the master controller 104 to communicate with the memory module 1061-106N. For example, in one embodiment of the disclosure, the master controller 104 may be utilizing an SATA protocol to interact with the memory modules 1061-106N. In such an embodiment, the control circuitry 110 is configured to emulate a SATA interface. The control circuitry 110 can also manage other memory functions such as security features to regulate access to data stored in the memory module and wear leveling.

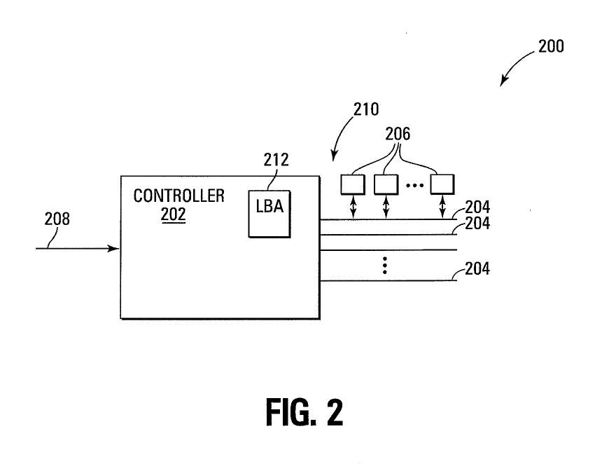

In one embodiment, shown in simplified form in FIG. 2, a solid state drive 200 has a controller 202 that controls a plurality of individual memory devices 206 such as flash devices on channels 204 of the drive 200. The controller 202 has a front end connection 208 such as SATA, SAS, PCIE, or the like, that can be connected to a processor (not shown). The processor provides instructions for the operation of the drive 200. At the back end 210, the controller 202 is connected to at least one channel 204. Channels 204 in one embodiment are wires that extend to memory devices 206.

In one embodiment, a channel is a group of wires with flash devices connected thereto on the wire and sharing a wire. Often the flash devices are multi-die packages, having 4 or 8 dies, for example. Each of the devices (flash devices or groups of flash devices) are connected to a controller using a channel. A single flash device may be connected to a channel in one embodiment, or multiple flash devices can share a channel in another embodiment. In an embodiment where one flash device is on each channel, the channels can be operated in parallel, that is, using each channel as a separate “drive.” With each channel treated as a separate drive in the system, there can be a number of channels connected to a single controller. Each channel is coupled to its own flash device or flash devices.

As stated above, each channel can be treated as its own drive. With that, the controller can use traditional redundant array of drives technology, such as redundant array of inexpensive disks (RAID) technology, to stripe data across multiple drives to improve data integrity. For example, with multiple channels, there is a parallel structure. Carrying that concept to a more broad base, a number of controllers can be used, each controller being connected to multiple channels, with each controller being treated as its own drive. Carrying the concept to a smaller scale, there can be multiple flash devices connected to each channel, with each of the flash devices being treated as its own drive. In these embodiments, the benefits of providing multiple parallel connections can take on a very large scale project all at the same time.

In the embodiment of FIG. 2, a number of parallel channels 204 are used. That is, the controller 202 has associated with and connected to it a plurality of channels 204, arranged in parallel. The channels 204 each have wires that extend to corresponding memory devices 206. As discussed above, channels 204 may have more than one memory device 206 connected thereto. Operations can be performed on multiple channels at once. Each channel has its own flash device or multiple flash devices 206, and each channel operates in parallel with other channels. This hierarchy allows for many concurrent operations on the drive 200.

In another embodiment, each channel is operated as its own drive. Many channels can be connected to each controller, and each channel is run in parallel. This configuration allows the controller to keep multiple drives busy at the same time.

In another embodiment, a drive can be comprised of any physical group of flash devices. It does not have to be channel-based. A programmable structure is created in this embodiment so that the host (e.g., a user of the host or the OS of the host) can decide how the flash devices are partitioned. For example, 16 drives can be created within the memory system (e.g., SSD 200), where a unique physical structure is assigned to each of those drives is created. In such an embodiment, the drives can be run as described herein using those 16 structures (regardless of whether they correspond to 16 physical channels).

A potential problem of read variability, as discussed above, may be improved by the assignment of certain physical addresses in the drive 200 to logical addresses that are used external to the drive 200, so that the controller 202 or external processor can control read, write, erase, and/or maintenance operations on the various channels 204 of the drive 200. For example, in another embodiment, a storage register (such as a logical block address (LBA) table) 212 is used to store details of the logical to physical translation between physical memory locations used by the physical memory and logical memory locations (e.g., LBAs) used by the host. For example, the physical addresses within the drive corresponding to the logical addresses the host uses to identify locations (e.g., physical addresses) of data in the drive are stored in the LBA table 212. The host sends logical addresses to the controller, which translates the logical addresses to physical addresses using the LBA table 212.

With multiple parallel channels in the drive, decisions can be made for writing to the device on the basis of bandwidth. For example, write commands issued by the host (e.g., through a memory access device) may be routed to a channel or channels that are not in heavy current use. The more memory devices 206 that work on a transfer, the faster the transfer can be made. However, there is a tradeoff in that the more devices working on a transfer, the more fragmented the data gets. Data may be striped to multiple channels on the device. The LBA table 212 typically hides the choice of data location to the controller or processor. The controller or processor simply provides a logical address, and the device itself reads or writes the data in or from the physical system.

With data being placed in multiple locations, and hidden from the controller and/or processor, a large amount of manipulation may be required to write and retrieve data. As data gets increasingly fragmented, blocks of memory of sufficient size to write data properly may become scarce. At this point, data reclamation (sometimes referred to as garbage collection) procedures are used to reclaim blocks of memory in order to allow additional writes to the memory. The more often data is physically moved on the drive, the faster the drive can wear out due to program erase cycles.

In order to more efficiently manage the writing of data to the memory, for example. one or more embodiments of the present invention create relationships between the logical locations typically used by the host and the physical memory with its physical locations typically used by the drive itself. For example, the LBA table 212 can be managed on a channel by channel basis. This allows such embodiments of the present invention to lower read variability, which increases when operations to read are attempted for a memory location that is being written to or erased. Since write or erase operations take significantly longer than read operations to complete, a read request to a portion of the memory that is being written to or erased could experience a significant delay. If a delay amount is known, a controller can compensate for read delay. However, when a read delay is unpredictable, the processes by which read delays are compensated are affected. The host can, using the present embodiments, know which logical addresses are assigned to which channels of the physical memory, from the LBA table. Using the LBA table, the host can assign write operations to different channels than concurrent read operations, allowing the parallel nature of the memory device to work in a predictable fashion.

For example, in one embodiment, the host is provided information showing which logical addresses are mapped to which physical channels of the drive 200, so that if a write or erase operation is occurring on a particular channel, read operations on that channel can be delayed until the write/erase operation is completed. Further, flash maintenance (e.g., data reclamation) is performed only on those channels that are being used for operations other than read operations. Reads are performed on different channels. If a channel has only read operations scheduled at a particular time or during a particular block of time, there will be no reclamation operations or other flash maintenance operations being performed on that particular channel that could affect read variability. In this way, read variability is reduced. That is, read operation timing is more closely known.

Embodiments of the present invention are also scalable both toward the front end and toward the back end. For example, additional channels 204 can be connected to the controller 202 provided the LBA table 212 is sufficiently sized. Also, additional flash devices 206 can be coupled to the channels 204, that is, instead of a single flash device 206 on a channel 204, multiple flash devices 206 can be connected to each channel 204, and each flash device 206 can operate in one embodiment in parallel with other flash devices 206 even on the same channel 204. Because of this multiple parallel structure, embodiments of the present invention lend themselves to the application of RAID principles, for example, using a RAID controller (or other redundant array controller) as the controller 202. In such an embodiment, the controller 202 operates each channel 204 as an independent drive in a redundant array of drives. This allows all the advantages of RAID technology, for example. with the speed of flash memory.

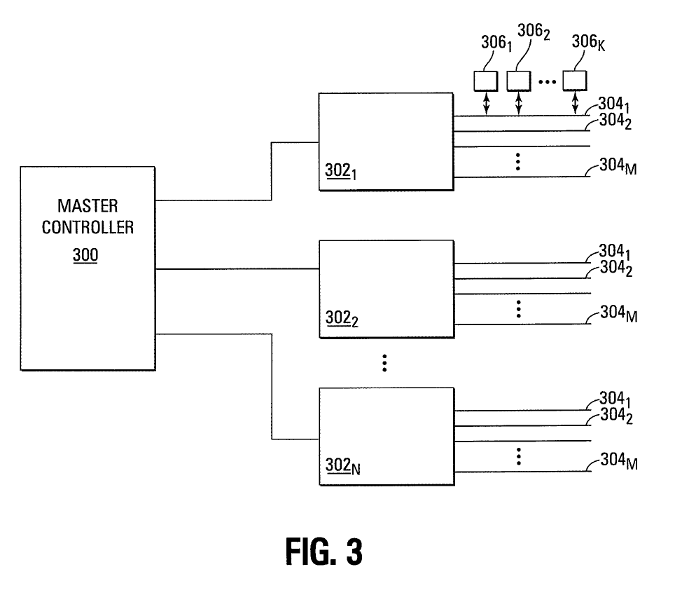

A series of controllers 302₁, 302₂, . . . , 302_{N}, as shown in FIG. 3, can also be used as individual drives, each controller 302 being used as a drive in a redundant array controlled by a master redundant array controller 300. In turn, each controller 302₁, 302₂, . . . , 302_{N}, can in turn operate as a redundant array controller for multiple channels 304₁, 304₂, . . . , 304_{M} and even individual flash devices 306₁, 306₂, . . . , 306_{K} on channels. In this way, multiple levels of parallel processing are provided, and the benefits of redundant arrays may provide improvements in speed and reliability of the drives.

The scaling across multiple controllers, each capable of having multiple channels, and multiple drives, allows parallel processing across multiple flash devices. This parallel processing, down even to the individual flash device as one of a plurality of flash devices on a channel, allows for very fine splitting of data and higher throughput. Parallel flash devices allow each device, especially when operated within the confines of controlling read variability by not allowing concurrent reads and writes on the same channel, to be used more efficiently than a single device. Throughput is improved, and writing and reading becomes faster.

In various embodiments of the present invention, each flash channel in a multi-channel drive is established as a separate drive partition for the operating system and/or driver. The logical block address (LBA) table/s is/are set up to create a logical to physical relationship for each channel. This allows a host application (such as a host that controls operation of a controller) to control which channels of the multi-channel drive are performing writes and which channels are performing reads. This prevents read/write conflicts and read variability associated with program and erase operation conflicts. The host does not need to manage the flash garbage collection and/or wear leveling. Instead, such tasks are performed for specific channels when those channels are not in a read mode of operation, as determined by the assigning of the particular channel to read operations at the time.

Embodiments of the invention can address read variability in SSDs by creating individual drives for each flash channel. The flash channels can then be dedicated to reads or writes. The LBA tables are created such that there is a logical to physical relationship between each channel and a logical address range. This address range is communicated to the OS through standard partitioning (such as RAID) procedures. The multi-channel drive appears to the OS to be a traditional hard drive RAID controller or multiple disk drives. This allows the application to control which channels are performing read operations and which are performing write or erase operations. The read operations are not delayed by flash write or erase operation, which results in a read latency variability that is much better than in traditional flash devices.

The number of channels dedicated to read operations and the number of channels dedicated to write operations can be controlled to reflect the amount of bandwidth required by the application, and can be changed as requirements change. For example, a 16 channel system may have four channels for write operations and 12 channels for read operations. A protocol such as PCIe allows concurrent read and write operations, and this provides a convenient way to manage the application. This type of control can also be used to establish additional RAID features associates with multi-drive RAID controllers, as each separate channel can be treated as its own drive.

In operation, various embodiments of the present invention work as follows. A redundant array controller includes a logical block address (LBA) table that contains mapping information of logical addresses to physical addresses in a solid state drive. In one embodiment, the mapping is to individual channels within a solid state drive. In another embodiment, the mapping is to individual flash devices on channels within the solid state drive. In still another embodiment, there are multiple controllers, each controller acting as one drive of a redundant array, and having a master controller that is a redundant array controller. The concepts of such redundant array usage of flash devices, channels, and entire drives is scalable.

Software in the LBA table or software external to the drive can perform redundant array control on the drive. In this embodiment, each device can have error correction (such as ECC) so errors can be corrected. One way this is performed is to use the logical to physical relationships in the LBA table and provide the host or redundant array controller access to that data.

In a situation in which a write or a maintenance operation is being performed on a particular channel, the read variability goes up, that is, read times become less predictable. Various embodiments of the present invention give the host the opportunity to control which channels have read operations and which channels have write operations, since the host, through the LBA table access, knows which logical addresses correspond to which physical channels. Because of this, the channel dedications are known, and the host determines which channels are to be used for read operations based on the known addresses that are already performing write or maintenance operations.

The host is provided the relationship between the logical and physical address translation contained in the LBA. Each channel, for example, can be allocated to a certain range of logical addresses, and any logical address within the range is assigned to that physical channel.

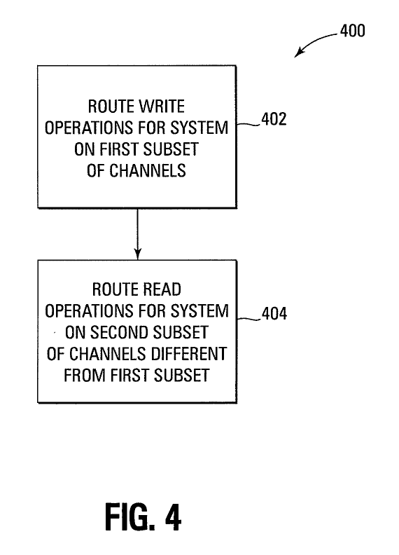

A method 400 of operating a solid state drive is shown in FIG. 4. The solid state drive has a plurality of channels, each channel being coupled to at least one flash device, as describe in further detail above. Method 400 comprises routing write operations for the solid state drive to a first subset of the plurality of channels in block 402, and routing read operations for the solid state drive to a second subset of the plurality of channels different from the first subset of the plurality of channels in block 404 when write operations are routed to the first subset of the plurality of channels. Further, the operations of the solid state drive are in another embodiment controlled by a redundant array controller, and the operations are controlled thereby.

The redundant array controller can include, for example, a logical block address table having mapping information of logical addresses used by the host to physical addresses used by the solid state drive. In this configuration, each of the plurality of channels comprises an individual drive in the redundant array. Individual flash devices on the channels could also be operated as individual drives in a redundant array, and be controlled by the controller. Still further, a plurality of redundant array controllers could be used, and controlled by a master redundant array controller, with each of the redundant array controllers operating as an individual drive in a redundant array controlled by the master redundant array controller. In this way, further nested parallel structures, in effect, redundant arrays within a redundant array, is embodied. The controller, be it a redundant array controller or a master redundant array controller, controls where incoming data gets striped, that is where the data gets written on the devices in the solid state drive.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for operating a memory system having a plurality of physical structures, the method comprising:
routing write operations for the memory system on a first subset of the plurality of physical structures; and
routing read operations for the memory system on a second subset of the plurality of physical structures different from the first subset of the plurality of physical structures when write operations are routed to the first subset of the plurality of physical structures.

2. The method of claim 1, wherein the plurality of physical structures are operated in parallel.

3. The method of claim 2, wherein routing write operations and routing read operations are performed by a redundant array controller.

4. The method of claim 3, wherein the redundant array controller includes a table having information on a logical to physical relationship between logical memory locations provided to the redundant array controller and physical memory locations corresponding to the plurality of physical structures, a respective set of logical memory locations corresponding to each physical structure.

5. The method of claim 1, and further comprising:
controlling the routing using a redundant array controller, wherein each of the plurality of channels comprises an individual drive in a redundant array.

6. The method of claim 5, wherein a plurality of redundant array controllers are used, each controller operating as an individual drive in a master redundant array.

7. The method of claim 1, wherein the physical structures are channels.

8. The method of claim 1, wherein write operations are routed to the memory system on the basis of bandwidth available on the first subset of the plurality of physical structures.

9. The method of claim 1, wherein each of the plurality of physical structures in the memory system is established as a separate drive partition for an operating system.

10. The method of claim 1, wherein each of the plurality of physical structures in the memory system is established as a separate drive partition for a driver for the memory system.

11. A method for operating a memory system, the method comprising:
assigning each channel of a plurality of channels of the memory system to a range of logical addresses;
storing information corresponding to the assignment of logical addresses;
providing a host the ranges of logical addresses corresponding to each of the plurality of channels; and
operating the solid state drive channels as individual drives in an array of redundant drives.

12. The method of claim 11, wherein operating the channels as individual drives in an array of redundant drives further comprises:
controlling routing of read operations to the memory system with a controller.

13. The method of claim 12, wherein controlling routing further comprises:
routing write operations for the memory system to a first subset of the plurality of channels; and
routing read operations to the memory system on a second subset of the plurality of channels different from the first subset of the plurality of channels when write operations are routed to the first subset of the plurality of channels.

14. A method of operating a memory system having an array of drives, comprising:
assigning each of a plurality of individual channels of a smemory system as an individual drive in the array;
storing information corresponding to a range of logical addresses corresponding to a range of physical addresses for each of the plurality of channels;
providing a host the stored information; and
controlling the plurality of individual channels.

15. The method of claim 14, wherein controlling further comprises:
routing read and write operations to different channels of the array to reduce read variability.

16. The method of claim 15, wherein routing further comprises:
routing write operations for the memory system to a first subset of the plurality of channels when a second subset of the plurality of channels different than the first subset is routed read operations.

17. The method of claim 16, wherein the second subset of the plurality of channels is exclusive of the first subset of the plurality of channels.

18. The method of claim 14, wherein a plurality of arrays are connected to a master array, and further comprising:
operating each of the plurality of arrays as an individual drive in a master array.

19. A memory system, comprising:
a plurality of channels, each channel being coupled to at least one solid state device;
a first subset of the plurality of channels, the first subset dedicated at a particular time to read operations; and
a second subset of the plurality of channels, the second subset being different than the first subset and dedicated at the particular time to non-read operations.

20. The memory system of claim 19, and further comprising:
a first redundant array controller, the controller connected to the plurality of channels, each channel operating as a drive in a redundant array of drives; and
a logical block address (LBA) table, the LBA table containing mapping information of physical addresses corresponding to individual channels of the plurality of channels and of logical addresses corresponding to the individual channels.

21. The memory system of claim 20, wherein each channel further comprises a plurality of flash devices connected thereto, each flash device of the plurality of flash devices connected to a respective channel operating in parallel thereon.

22. The memory system of claim 21, wherein the controller is one of a plurality of additional redundant array controllers, each connected in parallel with each other, each of the plurality of additional redundant array controllers comprising:
a plurality of channels, each channel being coupled to at least one solid state device; and
a logical block address (LBA) table, the LBA table containing mapping information of physical addresses corresponding to individual channels of the plurality of channels and of logical addresses corresponding to the individual channels; and
a master array controller connected to the plurality of additional redundant array controllers, each of the plurality of additional redundant array controllers operating as an individual drive in a master array.

23. A memory system, comprising:
a controller for controlling operation of an array of a plurality of channels of the memory system, wherein the controller is adapted to assign channels of the memory system to particular operations, the controller comprising:
a table having mapping information of logical addresses corresponding to physical channels of the memory system; and
a plurality of channel connections to the plurality of channels; and
at least one flash memory device, each of the at least one flash memory devices connected to one of the plurality of channels of the memory system, and each channel of the memory system connected to the controller.

24. The memory system of claim 23, wherein the controller further comprises a redundant array controller, and wherein each channel of the memory system is operated as a drive in the array.

25. The memory system of claim 23, wherein the table further includes mapping information of logical addresses corresponding to the at least one flash memory device;
wherein the controller further comprises a redundant array controller; and
wherein each flash device of the memory system is operated as a drive in a redundant array.

26. The memory system of claim 23, wherein each channel of the solid state drive has a plurality of logical addresses corresponding to the physical addresses of the plurality of flash devices connected to its respective channel, and wherein the controller is a redundant array controller capable of operating each respective channel as an individual drive in an array of redundant drives.

27. The memory system of claim 23, wherein the table is a logical block address table.

28. A redundant array of drives, comprising:
a controller; and
a plurality of individual solid state drives, each solid state drive coupled to the controller, and comprising:
a controller for controlling operation of an array of a plurality of channels of the solid state drive, wherein the controller is adapted to assign channels of the solid state drive to particular operations, the controller comprising:
a table having mapping information of logical addresses corresponding to physical channels of the solid state drive; and
a plurality of channel connections to the plurality of channels; and
at least one flash memory device, each of the at least one flash memory devices connected to one of the plurality of channels of the solid state drive, and each channel of the solid state connected to the controller.
